(19) United States
(12) Patent Application Publication
(10) Pub. No.: US 2011/0183558 A1
(43) Pub. Date: Jul. 28, 2011

(54) Coatings containing grouts or mortars

(76) Inventor: Patrick Ilfrey, White Bear Lake, MN (US)

(21) Appl. No.: 12/657,773

(22) Filed: Jan. 27, 2010

(51) Int. Cl. B32B 5/02; B05D 1/02; B05C 17/02; B05D 1/28; B05C 17/10; C04B 28/00; C04B 28/04; C04B 14/02; B32B 15/04; B32B 13/04; C04B 24/26

(52) U.S. Cl. 442/1; 427/142; 427/421.1; 427/428.01; 427/429; 427/356; 106/638; 106/713; 106/816; 428/457; 106/814; 106/716; 428/446; 524/2; 523/401

(57) ABSTRACT

Compositions useful as coatings, wherein the compositions comprise a coating material and a material selected from the group consisting of: mortars and grouts in admixture with the coating material. The coatings may be water-based or solvent-based, and may be epoxies, polyurethanes, polyaspartic ester polymers and polyureas in some embodiments. Compositions according to the disclosure exhibit enhanced physical properties compared with the same compositions made in the absence of a mortar or a grout as an ingredient. Compositions according to some embodiments have at least one of a mortar or grout, and optionally both, evenly dispersed within the bulk of a coating material prior to its application to a substrate sufficiently that the particles of the mortar or grout, or both when both are selected to be present, are substantially completely surrounded by a curable reactive mixture that cures to form a polymeric material useful as a coating.

### TECHNICAL FIELD

The present invention relates generally to coatings provided to various substrates, including without limitation, floor coatings. More particularly, it relates to coatings which are colored or tinted, using powdered or particulate forms of mortar or grout in different embodiments.

### BACKGROUND OF THE INVENTION

Various coatings materials are known in the art, including paints and varnishes. In addition, many two-part coatings compositions are also in widespread use, including without limitation: polyurethane coatings, epoxy coatings, polyurea coatings, and polyaspartic ester coatings. Generally speaking, two-part coatings are prepared by providing a first material and a second material that is reactive towards the first material, which first material and second materials, subsequent to their being combined, yield a reactive mixture which cures over time to provide a polymeric material. Typically, to apply such a coating to a substrate such as a floor, a person causes admixture of the first material with the second material, and then physically spreads or distributes the reactive mixture so formed over a substrate that is desired to be coated. Subsequent to the curing of the reactive mixture, which may take from between a few hours to a few days depending on the chemistry selected, the thickness of the coating, the presence of catalysts, etc., the material cures to form a layer of coating on the substrate.

Towards giving end-use customers options relating to the appearance of coatings, manufacturers of coatings compositions have in the prior art provided products which are pigmented, so that coatings are generally available in a wide range of colors, selectable by the end-user much as a person is able to enter a paint store and select a custom color. The art of coloring coatings is indeed an old one, as relics from archaeological digs have shown paleo-era people were using red iron oxide as a pigment over a thousand years ago. The use of metallic oxides as pigments continues to this day, red iron oxide pigments still being available and used in imparting coloration or tint to many types of compositions, including those intended as coatings for substrates. In some embodiments of the prior art, sand or quartz particles are broadcast onto a coating after its application to a substrate but prior to its having dried or cured, to enhance wear characteristics of the coating, such as when sand is broadcast onto floor coatings to provide increased friction.

Paints and coatings compositions often include colorant particles dispersed in a resinous binder. A paint composition may further include reflective pigments such as aluminum flake, micas, or other color-effect pigment compositions or substrate-hiding materials such as titanium dioxide, zinc oxide, and lead oxide. The dispersions required for the pigment loading can be expensive and contain large amounts of solvents that can contribute to high VOC levels and make the coatings hazardous to transport thus increasing the cost to market. The present disclosure provides methods of preparing protective and decorative coatings for application to various substrates and having a color which is either pre-specified or which matches a pre-selected coating composition selected from a minimum quantity of colorants which also enhances the physical properties of the finished coatings, after their cure.

### SUMMARY OF THE INVENTION

Compositions of matter useful as coatings for substrates, comprising a coating material in combination with at least one other material selected from the group consisting of: mortars and grouts, wherein the at least one other material is evenly distributed within the bulk of said composition. Also provided are processes for providing coatings on various substrates, which include dispensing a composition according to the disclosure onto a substrate, spreading the composition as desired about the substrate, and permitting the composition to cure to form a polymeric coating on the substrate. A composition according to the disclosure may be applied to a substrate using an implement selected from the group consisting of: rollers, brushes, squeegees, spatulas, and spray-generating equipment, and any other known equipment useful for spreading coating layers onto substrates.

### DETAILED DESCRIPTION

The present disclosure provides coating materials useful for coating various substrates including without limitation floors and walls, which coating materials in some embodiments contain a colorant in an effective amount to change the color of the coating materials, as compared to the same coating materials in the absence of the colorant according to this disclosure. In some embodiments of the disclosure, a colorant present in a curable reactive mixture comprises a grout. In other embodiments, a colorant present in a curable reactive mixture comprises a mortar. In some embodiments of the disclosure, the colorant present in a curable reactive mixture comprises both a grout and a mortar.

As used herein, “grout” is used in its ordinary sense, its meaning including powders or particulates which when mixed with water yield workable mortars or plasters useful for filling cracks and crevices in masonry, which cure over time to form a rock-like material. One exemplary grout is PermaColor™ Grout (in various colors offered) made by LATICRETE International, Inc., of Bethany, Conn., and including those described in U.S. Pat. No. 6,784,229. Other exemplary grouts include those sold under the Polyblend® trademark made by Custom Building Products (“CBP”) of Seal Beach, Calif. Grouts useful in accordance with this disclosure include grouts sold into the ceramic tile industry, which include both sanded grouts and un-sanded grouts, which may or may not contain color-imparting additives. Some grouts are sold in sacks or bags, intended to be admixed with water to form a paste having about the consistency of peanut butter, which is intended to be applied to spaces intentionally caused to be present between individual tiles on a floor or wall surface. Moreover, grouts used in accordance with this disclosure may optionally contain effective amounts of performance-enhancing additives, such as polymeric materials including without limitation acrylic polymers and/or latex polymers, as known in the art, to reduce the material's tendency to shrink during cure upon rapid loss of moisture by evaporation when such grouts are used in their intended application, rendering it un-necessary for workmen to assure a continued amount of moisture is present during the grout's cure. Additionally, grouts used in accordance with this disclosure may include effective amounts of stain resistance additives, for reducing the propensity of such grouts to becoming discolored in their intended use after cure when subjected to a substance that might otherwise cause a change in their color, after curing, such as by exposure to spilled beverages and other substances recognized as being capable of staining grout. One exemplary material is Ceramic Microspheres W-610™ available from the 3M Company. Thus, in a composition according to some embodiments of the disclosure, ceramic microspheres and glass bubbles may be present in any amount between about 0.5% by weight and about 10% by weight based on the total weight of the composition, including all percentages and ranges of percentages therebetween. In compositions according to other embodiments, ceramic microspheres and glass bubbles may be present in any amount between about 1% by weight and about 8% by weight based on the total weight of the composition, including all percentages and ranges of percentages therebetween. In compositions according to other embodiments, ceramic microspheres and glass bubbles may be independently present in any amount between about 2% by weight and about 6% by weight based on the total weight of the composition, including all percentages and ranges of percentages therebetween. Ceramic microspheres and glass bubbles tend to increase opacity in a cured coating according to the disclosure.

As used herein, “mortar” is used in it ordinary sense, its meaning including powders or particulates which when mixed with water yield a workable paste that is useful for binding construction blocks, bricks, stones, etc. to one another in masonry structures. Mortars may or may not include color-imparting additives. Mortar includes portland cement mortars, and any powdered substance containing clinker that has been ground into particulate form. One exemplary mortar is ProLite Rapid Set Tile and Stone Mortar from Custom Building Products (“CBP”). Other exemplary mortars are those sold under the Ultralite Mortar™ trademark by Mapei Corporation, a global company headquartered in Italy.

Grouts and mortars used as colorants herein may themselves each be colored in some embodiments, comprising conventional colorant materials known in the art including without limitation various metal oxides, minerals, metallic particles, organic dyes, and other colored materials including those which are crystalline and those which are amorphous, such as lampblack. In other embodiments, the grouts and mortars are themselves un-colored, that is, they themselves do not contain any materials which impart any coloration other than the inherent colorant characteristics of the grout or mortar absent added materials that impart color or tint.

Curable reactive mixtures are chemical compositions which comprise two different chemical materials, in admixture with one another, which compositions cure over time to form polymeric materials. One example of a curable reactive mixture is a mixture comprising an organic polyisocyanate and an organic polyol, which yields a polyurethane coating upon curing. Another example of a curable reactive mixture is a mixture of an organic polyisocyanate with an organic polyamine, which yields a polyurea coating upon curing. Another example of a curable reactive mixture is a mixture of an organic polyisocyanate with an polyaspartic ester, which yields a polyaspartic polyurethane coating upon curing. Another example of a curable reactive mixture is a mixture of an organic polyepoxide with an organic polyamine, which yields an epoxy coating upon curing. In these exemplary materials, those of ordinary skill recognize that the components present which react with one another may be present in either stoichiometric or substantially-stoichiometric amounts with respect to one another, at the option of the formulator, with stoichiometric amounts being often advisable. In general, since curable reactive mixtures comprise chemical materials which react with one another to provided a polymeric substance useful as a coating, the chemical materials are kept separate from one another until the time at which the mixture is to be added to and dispersed over a substrate, as is known in the art to provide a coating. In one non-limiting example, a polyol is provided in a first container along with plasticizers, catalysts, fillers, and other materials selected by the formulator to be present, and at the work site at which a coating is to be applied, a second container containing an organic polyisocyanate has its contents added to the first container. The substances are mixed to provide a curable reactive mixture, which is then dispensed onto a substrate such as by pouring, for distribution about the substrate. In one embodiment, the substrate is a floor surface, and further distribution is carried out using a squeegee or other implements known in the art for spreading liquid substances onto substrates into layers of desired thicknesses. This includes the use of spray guns and spray texture hoppers including SPRAYMATE™ drywall hopper HG692 gun marketed by Marshalltown Trowel Company Substrates other than floors to which a curable reactive mixture as provided herein may be dispersed include without limitation walls, railcars, roads, motorized vehicles, cargo containers, architecture, processing equipment, sea-going vessels, roofs, decks, ceilings, walls and all substrates desirably coated by a polymeric coating.

Thus, in various embodiments, a curable reactive mixture is provided which contains complementary reactive substances, and which provides a polymeric product after curing over time, which product may include without limitation, a floor coating. One example of complementary reactive substances is an organic polyisocyanate and an organic polyamine, which form a polyurea polymer after mixing and curing. Another example of complementary reactive substances is an organic polyisocyanate and an organic polyol, which form a polyurethane polymer after mixing and curing. Another example of complementary reactive substances is an organic polyepoxide and an organic polyamine, which form an epoxy polymer after mixing and curing. Another example of complementary reactive substances is an organic polyisocyanate and a polyaspartic ester, which form a polyaspartate polymer after mixing and curing.

Compositions from which polyurethane and polyurea materials may be produced typically contain at least one organic polyisocyanate compound. Organic polyisocyanates useful in accordance with this disclosure may be selected from any number of suitable aromatic or aliphatic-based polyisocyanates, such as toluene di-isocyanate, di-phenylmethane di-isocyanates, and isocyanate-containing prepolymers or quasi-prepolymers. These are standard isocyanate materials known to those skilled in the art. Preferred exemplary materials include MDI-based quasi-prepolymers such as those available commercially as RUBINATE® 9480, RUBINATE® 9484, and RUBINATE® 9495 from Huntsman International, LLC. Suitable aromatic polyisocyanates also include p-phenylene di-isocyanate, polymethylene polyphenylisocyanate, 2,6-toluene di-isocyanate, dianisidine di-isocyanate, bitolylene di-isocyanate, naphthalene-1,4-di-isocyanate, bis(4-isocyanatophenyl)methane, bis(3-methyl-3-iso-cyanatophenyl)methane, bis(3-methyl-4-isocyanatophenyl) methane, and 4,4′-diphenylpropane di-isocyanate. Other aromatic polyisocyanates useful in accordance with this disclosure are methylene-bridged polyphenyl polyisocyanate mixtures which have a functionality of from about 2 to about 4. These latter isocyanate compounds are generally produced by the phosgenation of corresponding methylene bridged polyphenyl polyamines, which are conventionally produced by the reaction of formaldehyde and primary aromatic amines, such as aniline, in the presence of hydrochloric acid and/or other acidic catalysts. Known processes for preparing polyamines and corresponding methylene-bridged polyphenyl polyisocyanates therefrom are described in the literature and in many patents, for example, U.S. Pat. Nos. 2,683,730; 2,950,263; 3,012,008; 3,344,162 and 3,362,979. Usually, methylene-bridged polyphenyl polyisocyanate mixtures contain about 20 to about 100 weight percent methylene di-phenyl-di-isocyanate isomers, with the remainder being polymethylene polyphenyl di-isocyanates having higher functionalities and higher molecular weights. Typical of these are polyphenyl polyisocyanate mixtures containing about 20 to about 100 weight percent di-phenyl-di-isocyanate isomers, of which about 20 to about 95 weight percent thereof is the 4,4′-isomer with the remainder being polymethylene polyphenyl polyisocyanates of higher molecular weight and functionality that have an average functionality of from about 2.1 to about 3.5. These isocyanate mixtures are known, commercially available materials and can be prepared by the process described in U.S. Pat. No. 3,362,979. One useful aromatic polyisocyanate is methylene bis(4-phenylisocyanate) or MDI. Pure MDI, quasi-prepolymers of MDI, modified pure MDI, etc. are useful as an ingredient present in a pouch 7 or 9 herein. Since pure MDI is a solid and, thus, often inconvenient to use, liquid products based on MDI or methylene bis(4-phenylisocyanate) are also useful herein. U.S. Pat. No. 3,394,164 describes a liquid MDI product. More generally, uretonimine modified pure MDI is included also. This product is made by heating pure distilled MDI in the presence of a catalyst. The liquid product is a mixture of pure MDI and modified MDI. The term isocyanate also includes quasi-prepolymers of isocyanates or polyisocyanates with active hydrogen containing materials. A hydrogen is an active hydrogen if it is capable of participating in the Zerevitinov reaction (Th. Zerevitinov, Berichte 40, 2023 (1907) to liberate methane from methylmagnesium bromide.

Any of the isocyanates mentioned above may be used as an, or in an, isocyanate component in a curable reactive mixture of the present invention, either alone or in combination with any other aforementioned isocyanates. Other polyisocyanates and mixtures including polyisocyanates may be employed as those of ordinary skill will realize after considering this disclosure.

The isocyanates can also be selected from aliphatic isocyanates of the type described in U.S. Pat. No. 4,748,192. These include aliphatic di-isocyanates and, more particularly, are the trimerized or the biuretic form of an aliphatic di-isocyanate, such as hexamethylene di-isocyanate (“HDI”), or the bi-functional monomer of the tetraalkyl xylene di-isocyanate, such as the tetramethyl xylene di-isocyanate. Cyclohexane di-isocyanate is also to be considered a useful aliphatic isocyanate. Other useful aliphatic polyisocyanates are described in U.S. Pat. No. 4,705,814. They include aliphatic di-isocyanates, for example, alkylene di-isocyanates with 4 to 12 carbon atoms in the alkylene radical, such as 1,12-dodecane di-isocyanate and 1,4-tetramethylene di-isocyanate. Also useful are cycloaliphatic di-isocyanates, such as 1,3 and 1,4-cyclohexane di-isocyanate as well as any mixture of these isomers, 1-isocyanato-3,3,5-trimethyl-5-isocyanatomethylcyclohexane (isophorone di-isocyanate); 4,4′-,2,2′- and 2,4′-dicyclohexylmethane di-isocyanate as well as the corresponding isomer mixtures, and the like. All patent documents mentioned in this disclosure are herein incorporated by reference thereto. Generally speaking, the organic isocyanate used is an organic polyisocyanate, having more than one isocyanate reactive group present in the molecule; the term “isocyanate” as used in this disclosure and its appended claims includes polyisocyanates.

When it is desired to provide a reactive mixture according to the disclosure that yields a curable epoxy, one of the materials present in the mixture is selected to be any material or mixture of two or more materials which contains at least two epoxy (epoxide) groups in its(their) molecular structure. Materials useful in providing curable epoxy mixtures are well-known in the art and the present disclosure provides for the use of all known organic epoxy resins, including without limitation epoxy NOVOLAC D.E.N.® 438 resin, ARALDITE® EPN 1180 resin, and NOVOLAC D.E.N.® 431 resin, and other epoxy resins specified in US Patent Application US 2005/0234216. Moreover, polyamines mentioned therein are also useful in providing a curable reactive mixture according to the disclosure.

For instances in which a curable reactive mixture provided in accordance with the disclosure is a reactive mixture from which either a curable epoxy or polyurea composition results, a polyamine will be present in the mixture. Polyamines useful for providing polyureas and cured epoxies are well-known in the art, and the present disclosure includes the use of any and all organic polyamines known to be useful in providing cured epoxies and polyureas. These include primary and secondary polyamines, whether they are aliphatic, aromatic or polyether polyamines, including without limitation those suitable polyamines sold under the JEFFAMINE® trademark and other trademarks by the Huntsman family of companies including Huntsman International, LLC.

Polyols useful for providing curable reactive mixtures from which polyurethane polymers result are well-known in the art, and the present disclosure includes the use of any and all organic polyols, mixtures thereof, and mixtures including same, known by those skilled in the art to be useful in providing cured polyurethanes.

A curable reactive mixture provided according to the disclosure may optionally contain, without limitation, any number of combinations of materials, as desired, selected from the group consisting of: diluents, catalysts that catalyze the reaction between the components of the mixture, fillers, colorants, plasticizers, stabilizers, preservatives, pre-polymers, uv light inhibitors, and crosslinking agents. A reactive mixture as provided herein may contain any substance generally recognized in the art as being beneficial or desirable when present in a mixture from which a curable material results over the course of time after the mixture is produced by mixing its components with one another.

To provide a curable reactive mixture in accordance with the present disclosure, a grout or mortar is provided, in addition to other ingredients or components selected to be present, and the components are blended to provide a composition wherein the mortar or grout is evenly distributed within the bulk of the resulting composition. In various embodiments the grout or mortar, as selected, is combined with and blended or mixed until a uniform mixture results with: 1) a component material that is subsequently blended with other component materials to arrive at a curable reactive mixture from which a coating ultimately results; or 2) a curable reactive mixture from which a coating ultimately results that already contains all components selected or desired, excepting the grout or mortar selected. In some embodiments, mixing of the grout or mortar with other materials selected to be present is accomplished by adding the mortar or grout as desired to the other chosen components, which typically include a coating material, and mixing the materials mechanically, using equipment recognized in the art as being suitable for providing mixtures, including without limitation motor-driven mixing blades, screw extruders, mills, and mixing equipment capable of providing mixtures of coating materials with an added mortar or grout wherein the mortar or grout is evenly distributed within the bulk of the resulting composition.

The amount of mortar or grout present in a curable reactive mixture according to embodiments of this disclosure is any amount between about 5% and about 80% by volume based on the total volume of the curable reactive mixture, including all ranges of volume percentages and all volume percentages therebetween. In other embodiments, the amount of mortar or grout present in a curable reactive mixture according to the disclosure is any amount between about 20% and about 65% by volume based on the total volume of the curable reactive mixture, including all ranges of volume percentages and all volume percentages therebetween. When volume measure is referred to in this disclosure, the grout or mortar is measured using dry measure equipment, and the grout or mortar is used as-is generally supplied in current commerce, without any compression of the material. In one non-limiting example, 1000 cc's of CFFS Polyurea 350′ product was poured into a tared 1 liter measuring cylinder and the mass determined to be 985 grams. In one non-limiting example, 1000 cc's of Polyblend non-sanded grout product was poured into a tared 1 liter measuring cylinder and the mass determined to be 1132 grams. In one non-limiting example, 1000 cc's of Polyblend sanded grout product was poured into a tared 1 liter measuring cylinder and the mass determined to be 1732 grams. In one non-limiting example, 1000 cc's of VERSABOND™ mortar product was poured into a tared 1 liter measuring cylinder and the mass determined to be 1662 grams. Thus, a curable reactive mixture according to this disclosure may contain any amount between about 5% by weight and about 88% by weight of mortar or grout (or mixtures thereof, in any proportions), based on the total weight of the curable reactive mixture, including all percents by weight and ranges of percents by weight therebetween.

A mortar or grout present in a curable reactive mixture according to some embodiments is in particulate form. In some embodiments the average size of the particles of grout or mortar is any size between about 15 microns and about 350 microns, including materials having all average particle sizes and ranges of average particle sizes therebetween.

In any event, some grouts and mortars are known to react with water or moisture, which when present in a curable reactive mixture according to the disclosure are capable of absorbing water or moisture which otherwise might react with a reactant present in a curable reactive mixture as provided. Such reaction could be between trace amounts of water present in a polyol, which when mixed with a polyisocyanate, some of the water would react with the isocyanate groups to effectively reduce the number of isocyanate groups present and able to react with the polyol, thus yielding a coating having fewer urethane linkages and accordingly of less integrity than would have been the case where the water had not so detrimentally impacted the isocyanate content. When present in a curable reactive mixture provided herein, the particles of mortar or grout selected become encapsulated within the curable reactive mixture, which, when uncolored mortars or grouts are used, imparts an off white tint to the curable reactive mixture and resultant coating, allowing the color of the grout or mortar to show as the color of the coating as it appears to an observer. The mortar or grout particles provide strength and act as a filler, which allows the curable reactive mixture to cure properly when applied at a thickness required for a specific application. It is believed that the mortar or grout being either cement based, acrylic or polymer enhanced is at some level activated by the latent moisture introduced during packaging, storage, mixing or application of the curable reactive mixture to a substrate. Moreover, it has been found that the presence of grouts or mortars in a curable reactive mixture as provided herein provide finished coatings having enhanced physical properties above what would be expected from merely absorbing or removing water or moisture as a consideration, as shown below.

To determine physical properties of compositions according to this disclosure, a variety of sample materials were prepared by blending the materials specified in the examples in Table I below. Single coatings of these materials were applied to Masonite® substrates using a brush, except example 2 which was applied using a roller. Coatings thicknesses was about 250 microns.

TABLE I
samples formulations

| Example | | | | |
|---|---|---|---|---|
| No. | Coating Composition | Grout | Tint | Acetone |
| 1 | CFFS 350 ™ polyurea | 0 | 10% red | 0 |
| 2 | CFFS 350 ™ polyurea | 25% S | 10% white | 0 |
| 3 | CFFS 350 ™ polyurea | 50% NS | 2% white | 10% |
| 4 | CFFS 350 ™ polyurea | 100% NS | 2% white | 10% |
| 5 | CFFS 350 ™ polyurea | 100% NS | 2% white | 0 |
| 6 | CFFS 350 ™ polyurea | 100% NS | 2% white | 0 |
| 7 | CFFS RG-80 ™ polyurea | 0 | 0 | 0 |
| 8 | CFFS RG-80 ™ polyurea | 10% S | 10% white | 0 |
| 9 | CFFS RG-80 ™ polyurea | 10% NS | 10% tan | 0 |

In table I, percentages listed are specified on a volume basis, based on the amount of coating composition employed. For example, in Example 2, the 25% of sanded grout (“S”) added was calculated on the volume of CFFS Polyurea-350™ product employed. For 100 ml of the coating material of example 2, 25 ml of the grout and 10 ml of white tint was used, all of the ingredients in this and the other examples being blended using mechanical means until a mixture that is at least substantially-uniformly mixed results, to provide the coating composition. In example 4, a volume of non-sanded grout (“NS”) equal to that of the coating material employed, e.g., “100%”, and an amount of tint equal to 2% of the volume of the coating material were blended with the coating material to provide the coating composition. For the cases of grouts and mortars, their volume was determined “as-poured”, without any packing or compression. In the above table, the white and tan tint used in the examples was that supplied by Degussa under the trade name Evonik™ 844. For example 2, the sanded grout employed was from CBP. For examples 3, 4, 5, 8, 9 the non-sanded grout employed was from CBP, and for example 6, the non-sanded grout employed was product ID 1600 from Laticrete International Inc. Example 1 was coated onto the substrate, and after coating but prior to cure, vinyl chips having an average size of about ¼″ from Torginol Inc. of Sheboygan Falls, Wis. were broadcast onto the surface of the uncured coating to cover between about 10% and about 15% of the total area. Samples indicating the presence of acetone had the indicated amount of acetone by volume added, based on the amount of coating composition employed. Thus, example 3 was prepared by mixing one volume of coating composition, with 50% of that volume of non-sanded grout, 2% of the volume of coating composition of white tint, and 10% of the volume of the coating composition of acetone. All ingredients were mechanically mixed prior to application to the substrate.

Materials prepared as described above were tested for their surface hardness, and abrasion resistance.

For the hardness test, the method employed was ASTM D-3363, film pencil hardness. Ratings provided in table II below were based on the maximum pencil hardness that does not scratch the film surface, and hardness increases with increasing pencil H numbers. In addition, the Shore A indentor method was run on all samples and all samples in table II gave a reading of at least 100, which is equivalent to about a Shore D of about 70 or greater, the results being set forth in table II below:

TABLE II
hardness test results

| Example No. | ASTM D-3363 | Shore A Indentor |
|---|---|---|
| 1 | 4H | >100 |
| 2 | 6H | >100 |
| 3 | 5H | >100 |
| 4 | 6H | >100 |
| 5 | 5H | >100 |
| 6 | 4H | >100 |
| 7 | 5H | >100 |
| 8 | 6H | >100 |
| 9 | 5H | >100 |

Abrasion tests were performed on various samples having the formulations set forth in Table III below:

TABLE III
samples formulations for abrasion tests

| Example | | | | |
|---|---|---|---|---|
| No. | Coating Composition | Grout | Tint | Solvent |
| 10 | Citadel Traffic Coat (gray) | 0 | 0 | 0 |
| 11 | Rustoleum ™ DIY | 0 | 10% gray | 0 |
| | Sku 2-3005-203005A | | | |
| 12 | CFFS 350 ™ polyurea | 0 | 10% tan | 10% |
| | | | | acetone |
| 13 | CFFS 350 ™ polyurea | 100% | 1% white | 10% |
| | | fawn | | acetone |
| 14 | CFFS 350 ™ polyurea | 100% | 1% white | 0 |
| | | fawn | | |
| 15 | CFFS DIY topcoat | 100% | 1% white | 10% |
| | | fawn | | OXSOL |
| | | | | 100 |
| | | | | solvent |

In table III, Citadel Traffic Coat™ product in gray color is available from Citadel Floor Finishing Systems of Blaine, Minn. Oxsol 100 solvent is available from Occidental Chemical Corporation. Example 12 was prepared by mixing 100 volumes of the indicated coating composition with the tint and 10 volumes of acetone and mixing until a uniform mixture results, then spread onto a MASONITE® substrate. A uniform mixture is one in which the grout or mortar present is evenly distributed within the bulk of the final composition, the achievement of an even distribution of materials both liquids and solids by mechanical mixing being well-known in this art. Example 13 was prepared by mixing 150 milliliters (ml) of the indicated coating composition with the tint and 150 ml of POLYBLEND® non-sanded grout (sandstone color) from Custom Building Products (“CBP”) and 15 ml of acetone and mixing until uniform, then spread onto a MASONITE® substrate. Example 14 was prepared by mixing 150 milliliters (ml) of the indicated coating composition and the tint with 150 ml of CBP grout (prism “fawn” color) and mixing until uniform, then spread onto a MASONITE® substrate. Example 15 was prepared by mixing 150 milliliters (ml) of the indicated coating composition and the tint with 150 ml of CBP grout (“fawn” color) and 15 ml of acetone and mixing until uniform, then spread onto a MASONITE® substrate. All tints used in examples 1-6 above are Degussa 844 tints. Abrasion testing was done on the above materials disposed on flat MASONITE® substrates having a thickness of about three millimeters. After curing, the samples were sanded using a 5″ orbital sander model S1A-AJ2-1250 from Tool Shop from Menards of Eau Clair, Wis. A fresh sanding disk of grit 40 grade (3M company) was used for each sample and applied with hand pressure for sixty seconds. The weight losses of the samples after sanding compared to the freshly-cured samples were recorded and the samples were observed for visual appearance. The results are given in Table IV below:

TABLE IV
Abrasion test results

Sample weights
(grams)

| Sample | Before | After | Weight | |
|---|---|---|---|---|
| ID | Sanding | Sanding | loss | Visual appearance |
| 10 | 199 | 198.5 | 0.5 | Slight dulling |
| 11 | 198 | 196 | 2 | Coating completely |
| | | | | removed |
| 12 | 198 | 197 | 1 | Slight dulling |
| 13 | 205 | 204.5 | 0.5 | Slight dulling |
| 14 | 196 | 196 | 0 | Slight dulling |
| 15 | 194 | 193.5 | 0.5 | Slight dulling |

In some instances, traditionally, pigments for performance-based, non-water based coatings are extremely difficult to match with one another from a color perspective, and blend into coatings compositions without the use of harsh solvents or dispersions, which contribute to the total volatile organic content (“VOC”) of the coatings or the high cost of having to grind pigment(s) into the coating resin itself. This has limited the number of colors available in retail environments without this expensive option. Moreover, some coatings including DIY Polyurea Hybrid coatings available from RockSolid Floors Company of Blaine, Minn. react negatively to pigments present in dispersions, i.e., their physical properties are adversely affected by conventional pigments. A coating made from a curable reactive mixture according to this disclosure provides a remedy, enabling colored coatings to be produced having readily-matchable colors and superior physical performance properties. These may include one or more of increased chemical resistance, increased abrasion resistance, increased compressive strength, improved coefficients of friction for providing non-slip floor coatings, improved tensile strength of coatings, improved compressive strength of coatings, faster cure times and harder cures for single coat applications that can be driven on by an automobile within about 24 hours after application of the curable reactive mixture to a floor. Additionally, when proceeding according to this disclosure one also has the ability to use grouts having anti-microbial additives such as MOLD GUARD™ from Custom Building Products Company of Seal Beach, Calif., and MICROBAN™ from Laticrete International of Bethany Conn. which when selected to be present transfers anti-microbial properties to the coating system at appropriate loadings.

Generally, manufacturers of grouts employ sufficient quality control measures during manufacture which provide consistent coloration among grouts from lot to lot, which is directly transferable to a curable reactive mixture as provided herein. Many colors of grouts are readily available in multiple locations, from tile stores to Big Box retailers and smaller hardware stores, versus colored quartz or sands that are expensive and limited in availability that the end user must have shipped in via “special order.” A grout or mortar as used in accordance with this disclosure may also contain polymers well-known in the art as being useful for enabling cure of the grout when used alone without the need for controlling the loss of moisture from the grout during its curing. In popular grout formulae, acrylic polymers are present in such capacity.

Although described herein with reference to inclusion in a curable reactive mixture, colored grouts and mortars are also useful in many compositions which yield a coating after their cure. Thus, the teachings of the present disclosure are applicable to various coatings compositions including without limitation: latex paints, oil-based paints, acrylic paints, water-based acrylic coatings, solvent-based acrylic coatings, water-based single-component urethane dispersions, solvent-based single-component urethane dispersions, polyurea coatings, water-based epoxy coatings, solvent-based epoxy coatings, water-based urethane coatings, moisture-cure urethane coatings, single-component polyurea coatings, and solvent-based urethane coatings.

Exemplary embodiments of compositions are set forth below, in which the ingredients specified are mechanically blended together until the grout or mortar material selected (and other components present) are at least substantially evenly distributed throughout the bulk of the resulting composition, i.e., an at least reasonably uniform mixture is provided:

### Example 16

### Polyurea Hybrid Coating Composition

CFFS Polyurea-350™ product available from Citadel Floor Finishing Systems (“CFFS”) Company of Blaine, Minn. is blended 1:1 on a volume basis with Polyblend non-sanded grout in the color of “fawn” from Custom Building Products (“CBP”), Seal Beach, Calif. An additional 10% by volume based on the total volume of the CFFS Polyurea-350™ product used of Prism fawn grout from CBP is added and the mixture is further diluted with acetone in an amount of 10% by volume of the CFFS Polyurea-350™ product used. These materials are made into a uniform mixture using a mechanical mixing blade, subsequently dispersed onto a concrete floor surface, rolled out to an even layer with a ⅜″ nap 9″ roller and permitted to cure to provide a cured, colored polyurea floor coating.

### Example 17

### Polyurea Hybrid Coating Composition

CFFS Polyurea-350™ product available from CFFS Company of Blaine, Minn. is blended with 10% by volume based on the amount of CFFS Polyurea-350™ product present, of white Degussa 844 tint (Degussa Company) and the reslutling mixture is blended in a 1:1 volume amount with Polyblend sanded grout fawn color from CBP. The resulting composition is made into a uniform mixture using mechanical mixing and subsequently applied to a concrete floor using a ⅛″ notched squeegee.

### Example 18

### Polyurea Hybrid Coating Composition

CFFS Polyurea-350™ product available from CFFS Company of Blaine, Minn. is blended 1:1 by volume with PERMACOLOR™ grout in “latte” color, from Laticrete International. The resulting mixture is further diluted with xylene in an amount of 10% by volume based on the Polyurea-350™ product/PERMACOLOR™ grout mixture and mixed until a uniform final mixture results. This final mixture is applied to a concrete floor and rolled out with an ⅜″ nap 18″ roller.

### Example 19

### Polyurea Hybrid Coating Composition

CFFS Polyurea-350™ product available from CFFS of Blaine, Minn. is combined with 5% by volume based on the Polyurea-350™ product of white CFFS universal tint (from CFFS) and blended. Subsequently, the resulting blend is mixed in a: 1 volume amount of POLYBLEND™ non-sanded grout in “fawn” color from CBP and mixed until a uniform final mixture results. The resulting mixture is applied to a concrete floor surface with a micro trowel.

### Example 20

### Urethane Concrete Repair Composition

Two parts of CFFS FORTIFICATION FORMULA™ product, available from CFFS of Blaine, Minn. is combined with POLYBLEND™ non-sanded grout in “fawn” color from CBP in a 2:1 volume ratio, respectively, and mixed until a uniform final mixture results. The resulting mixture is applied by pouring directly into or onto a defect in a concrete surface and smoothed out with a micro trowel.

### Example 21

### Urethane Concrete Repair Composition CFFS FORTIFICATION FORMULA™ product, available from CFFS of Blaine, Minn. is combined 1:1 by volume with POLYBLEND™ non-sanded grout in “fawn” color from CBP and mixed until a uniform final mixture results. The resulting mixture is applied by pouring directly into or onto a defect in a concrete surface and smoothed using a micro trowel.

### Example 22

### Urethane Concrete Repair Composition

CFFS FORTIFICATION FORMULA™ product, available from CFFS of Blaine, Minn. is combined 1:1 by volume with KERACOLOR™ S sanded grout from MAPEI Corporation, and mixed until a uniform final mixture results. The resulting mixture is applied by pouring directly into or onto a defect in a concrete surface and is smoothed using a micro trowel.

### Example 23

### Polyurea Coating Composition

CFFS 511™ primer product, available from CFFS of Blaine, Minn. is applied to a concrete floor. A mixture is prepared comprising 99.95% by weight of RG80™ base product, available from CFFS and 0.05% by weight titanium dioxide white tint. This mixture of TiO2 and RG 80™ product is then blended on a 1:1 volume basis with POLYBLEND™ non-sanded grout in “fawn” color from CBP until a uniform final mixture results. The resulting mixture is applied to the concrete with a micro trowel. Subsequently, the surface is optionally top coated with CFFS PG-100™ from CFFS.

### Example 24

Ace Gloss Oil Accent Colors, 2.5 oz (liquid volume) of Paint blended until uniform with 50% loading by liquid volume Non-Sanded Custom Building Products Grout “Haystack” color (1.25 oz.).

### Example 25

Ace Gloss Oil Accent Colors, 2.5 oz (liquid volume) of Paint blended until uniform with 50% loading by liquid volume SANDED Custom Building Products Grout “Tobacco Brown” color (1.25 oz.).

### Example 26

Ace Gloss Oil Accent Colors, 2.5 oz (liquid volume) of Paint blended until uniform with 50% loading by liquid volume Non-Sanded Mapei Grout “14” Color (1.25 oz.).

### Example 27

Ace Gloss Oil Accent Colors, 2.5 oz (liquid volume) of Paint blended until uniform with 50% loading by liquid volume SANDED Mapei Grout “27” (1.25 oz).

### Example 28

Ace Gloss Oil Accent Colors, 2.5 oz (liquid volume) of Paint blended until uniform with 100% loading by liquid volume PRISM Custom Building Products Grout “Brown” (1.25 oz.).

### Example 29

Ace Gloss Oil Accent Colors, 2.5 oz (liquid volume) of Paint blended until uniform with 50% loading by liquid volume PRISM Custom Building Products Grout “Brown” (1.25 oz.).

### Example 30

Zinsser 1.2.3. Bullseye Primer 2.5 oz (liquid volume) of paint blended until uniform with 50% loading by liquid volume Non-Sanded Custom Building Products Grout “Haystack” color (1.25 oz.).

### Example 31

Zinsser 1.2.3. Bullseye Primer 2.5 oz (liquid volume) of paint blended until uniform with 50% loading by liquid volume SANDED Custom Building Products Grout “Tobacco Brown” color (1.25 oz.).

### Example 32

Zinsser 1.2.3. Bullseye Primer 2.5 oz (liquid volume) of paint blended until uniform with 50% loading by liquid volume Non-Sanded Mapei Grout “14” Col or (1.25 oz.).

### Example 33

Zinsser 1.2.3. Bullseye Primer 2.5 oz (liquid volume) of paint blended until uniform with 50% loading by liquid volume SANDED Mapei Grout “27” (1.25 oz.).

### Example 34

Zinsser 1.2.3. Bullseye Primer 2.5 oz (liquid volume) of paint blended until uniform with 100% loading by liquid volume PRISM Custom Building Products Grout “Brown” (2.5 oz.).

### Example 35

Zinsser 1.2.3. Bullseye Primer 2.5 oz (liquid volume) of paint blended until uniform with 50% loading by liquid volume PRISM Custom Building Products Grout “Brown” (1.25 oz.).

### Example 36

Ace Semi-Gloss (100% Acrylic), 2.5 oz (liquid volume) paint blended until uniform with 50% loading by liquid volume Non-Sanded Custom Building Products Grout “Haystack” color (1.25 oz.).

### Example 37

Ace Semi-Gloss (100% Acrylic), 2.5 oz (liquid volume) paint blended until uniform with 50% loading by liquid volume SANDED Custom Building Products Grout “Tobacco Brown” color (1.25 oz.).

### Example 38

Ace Semi-Gloss (100% Acrylic), 2.5 oz (liquid volume) paint blended until uniform with 50% loading by liquid volume Non-Sanded Mapei Grout “14” Col or (1.25 oz.).

### Example 39

Ace Semi-Gloss (100% Acrylic), 2.5 oz (liquid volume) paint blended until uniform with 50% loading by liquid volume SANDED Mapei Grout “27” (1.25 oz.).

### Example 40

Ace Semi-Gloss (100% Acrylic), 2.5 oz (liquid volume) paint blended until uniform with 100% loading by liquid volume PRISM Custom Building Products Grout “Brown” (2.5 oz.).

### Example 41

Ace Semi-Gloss (100% Acrylic), 2.5 oz (liquid volume) paint blended until uniform with 50% loading by liquid volume PRISM Custom Building Products Grout “Brown” (1.25 oz.).

### Example 42

Killz Interior Oil base, 2.5 oz (liquid volume) of paint blended until uniform with 50% loading by liquid volume Non-Sanded Custom Building Products Grout “Hay stack” color (1.25 oz.).

### Example 43

Killz Interior Oil base, 2.5 oz (liquid volume) of paint blended until uniform with 50% loading by liquid volume SANDED Custom Building Products Grout “Tobacco Brown” color (1.25 oz.).

### Example 44

Killz Interior Oil base, 2.5 oz (liquid volume) of paint blended until uniform with 50% loading by liquid volume Non-Sanded Mapei Grout “14” Color (1.25 oz.).

### Example 45

Killz Interior Oil base, 2.5 oz (liquid volume) of paint blended until uniform with 50% loading by liquid volume SANDED Mapei Grout “2 7” (1.25 oz.).

### Example 46

Killz Interior Oil base, 2.5 oz (liquid volume) of paint blended until uniform with 100% loading by liquid volume PRISM Custom Building Products Grout “Brown” (2.5 oz.).

### Example 47

Killz Interior Oil base, 2.5 oz (liquid volume) of paint blended until uniform with 50% loading by liquid volume PRISM Custom Building Products Grout “Brown” (1.25 oz.).

### Example 48

### One-Day Curing

A concrete floor in a workshop area at an ambient temperature of about 70 degrees F. is profiled by grinding the surface with a 20-50 grit diamond wheel grinder, the moisture content of the concrete being less than 5.5% using a TRAMEX® 3 moisture meter. A first layer coating of CFFS-511™ polyurethane coating (Citadel) is applied at a rate of 400 square feet per gallon (sq. ft./gal.). The first layer is permitted to cure for 45 minutes, and a second layer comprising CFFS-511™ coating combined with POLYBLEND™ non-sanded grout in “fawn” color from CBP in a 2:1 volume ratio is applied at a rate of 400 sq. ft./gal. The second layer is permitted to cure for 45 minutes, and a top layer comprising CFFS-511™ coating combined with POLYBLEND™ non-sanded grout in “fawn” color from CBP in a 2:1 volume ratio is applied at a rate of 400 sq. ft./gal. After an additional 2 hours, the multi-layer coated structure is ready for normal traffic and use.

Compositions according to some embodiments are provided by blending the components selected to be present with one another until a uniform mixture results, as such uniform mixtures are typically recognized employed by those in the coatings arts using sufficient mechanical mixing. Thus this disclosure provides embodiments in which the grout or mortar, or both, selected to be present is/are substantially-uniformly distributed throughout the composition provided and wherein the vast majority of (and in alternate embodiments, substantially all of) the particles of grout or mortar present are each surrounded on all sides by the coating material chosen.

A composition according to some embodiments provides increased compression strength in the finished coating due to the particle size that acts as filler and strengthens the coating system.

Additionally, in some embodiments a composition according to the disclosure provides increased adhesion to moist concrete as compared with the same coating material having no grout or mortar in its composition.

Test materials were mixed and test results on the composition of the materials are laid out in Table V below, in which the white tint employed was from Degussa and the grout was from CBP. In example 49, 150 ml of the coating composition was mixed with 150 ml of the grout and 15 ml of tint to arrive at the final composition.

TABLE V
samples formulations for abrasion tests

| Example | | | | |
|---|---|---|---|---|
| No. | Coating Composition | Grout | Tint | Solvent |
| 49 | CFFS 350 ™ Polyurea | 100% | 10% white | 0 |
| 50 | CFFS 350 ™ Polyurea | 100% | 10% white | 0 |
| 51 | CFFS 350 ™ Polyurea | 100% | 10% white | 10% ace |
| 52 | CFFS Level-Hard ™ Epoxy | 0 | 0 | 0 |

Tests for tackiness, surface hardness, and adhesion were performed on each of the materials applied to moist concrete in a thickness of about eight (8) mils and permitted to cure normally; results are in table VI below:

TABLE VI

| Example | Tackiness | Hardness Scratch Test | Adhesion (p.s.i.) |
|---|---|---|---|
| 49 | 2 | A | 3 |
| 50 | 0 | C | 3.5 |
| 51 | 1 | B | 4 |
| 52 | 5 | A | 1 |

The tackiness test results are rated on a scale of from 0 to 10, with a rating of 10 describing the still-wet material at the time of its application, the test being conducted 24 hours after the time the coating was applied. The hardness scratch test was conducted by pushing the flat blade of a screwdriver across the coating while applying moderate hand pressure to the blade. In samples rated “A” the screwdriver blade left scratches and some of the coating material became un-bonded from the substrate in gouges. In the sample rated “B” the coating was indented but not gouged and the coating material did not become un-bonded. In the sample rated “C” only a faint scratch mark was left and none of the coating material became de-bonded from the substrate. The adhesion tests were performed using an Eclometer 106 adhesion tester and a rating scale of 0-5 p.s.i. according to AS™ D-4541-89 after the passage of 96 hours since application of the compositions to the moist concrete substrate. These results show that the addition of grout to the compositions causes the coating to adhere better to moist concrete according to the AS™ D-4541-89 test.

Further non-limiting exemplary illustrations of compositions according to this disclosure are illustrated in the examples which now follow, wherein the materials are blended until a uniform mixture is provided as is generally preferable for at least many embodiments of the invention:

### Example 49

### Asphalt Repair—4 Hour Return to Service

Polyurea 350™ from CFFS is mixed with equal parts by volume charcoal Polyblend Sanded grout from CPB. The product is spread over damaged asphalt using a micro trowel. The repair is than dusted with charcoal Polyblend Sanded grout from CPB and returned to service in 4 hours.

### Example 50

### Asphalt Repair—4 Hour Return to Service

1 part Polyurea 350 Arctic Blend is mixed with 2 parts by volume charcoal Polyblend Sanded grout from CPB. This blended mixture is poured into a pothole and spread with a mortar trowel. The repair is than dusted with charcoal Polyblend Sanded grout from CPB and returned to service in 4 hours.

### Example 51

### Liquid Carpet

EasyMat is applied to a plywood floor substrate as directed in the instructions from CBP. Polyurea 350 clear is mixed with equal parts by volume bone Polyblend Non-Sanded grout from CPB. This mixture is spread over the EasyMat using a ⅛″ notched squeegee and then back rolled with a ⅜″ roller. Within a 30 minute window the floor is covered by a broadcast of Torginol® chips “Saddl e Tan Blend” until rejection. The floor is allowed to cure for 2 hours and then a clear top coat of Poly-One single component Polyurea from CFFS is applied with a flat squeegee and back rolled with a ⅜″ roller. The floor is than ready for service in 8 hours.

### Example 52

### Liquid Carpet

Upon a plywood sub-floor Polyurea 350 clear is mixed with equal parts by volume Oyster Gray Polyblend Non-Sanded grout from CPB. This mixture is spread over the EasyMat using a ⅛″ notched squeegee and then back rolled with a ⅜″ roller. Within a 30 minute window the floor is covered by a broadcast of Torginol® chips “Domino” until rejection. The floor is allowed to cure for 2 hours and then a clear top coat of Level-Hard Epoxy from CFFS is applied with a flat squeegee and back rolled with a ⅜″ roller. The floor is than ready for service in 24 hours.

### Example 53

### Liquid Carpet

Upon a linoleum floor which has been sanded with 80 grit sandpaper and cleaned with Acetone Polyurea 350 clear is mixed with equal parts by volume Lipstick Polyblend Non-Sanded grout from CPB. This mixture is spread over the linoleum using a ⅛″ notched squeegee and then back rolled with a ⅜″ roller. Within a 30 minute window the floor is partially covered by a broadcast of Ultra Fine Glitter—Fire Cracker (SKU 1×412c) From Lure Craft in LaGrange, Ind. The floor is allowed to cure for 4 hours and then a clear top coat of RG80 from CFFS is applied with a ⅜″ roller. The floor is than ready for service in 6 hours.

### Example 54

### Underlayment

LevelQuick self leveling underlayment from CBP is installed per instructions onto a restaurant concrete floor. After 6 hours a Polyurea 350 custom base is mixed with equal parts by volume Sandstone Polyblend Non-Sanded grout from CPB. To this mixture both 10% by volume Bone Prism grout from CPB and Acetone are added. The resulting mixture is rolled onto the substrate with a ⅜″ roller and returned to full traffic in 24 hours.

### Example 55

### Underlayment

Ardex K-15 self leveling underlayment from ARDEX ENGINEERED CEMENTS of Aliquippa, Pa. is installed per instructions. After 16 hours a Polyurea 350 custom base is mixed with equal parts by volume Fawn Prism grout from CPB. To this mixture 10% by volume Acetone is added. The resulting mixture is rolled onto the substrate with a ⅜″ roller and returned to full traffic in 24 hours.

### Example 56

### Bed Liner

A pick-up truck steel bed is prepared by sanding with 80 grit sandpaper and cleaned with Acetone. Upon this surface a mixture of RockSolid DIY Bed liner combined with 50% by volume charcoal Polyblend Sanded grout from CPB is applied with a Spraymate Texture Hopper.

### Example 57

### Roof Repair

Upon an asphalt roof single Polyurea 350 custom base is mixed with equal parts by volume Bright White Prism grout from CPB. To this mixture 10% by volume Acetone is added. The resulting mixture is rolled onto the substrate with a ⅜″ roller.

### Example 58

### Wood Deck

Upon a wood exterior deck Polyurea-One from CFFS is mixed 25% by volume fawn Prism grout from CPB. The resulting mixture is rolled onto the substrate with a ⅜″ roller.

### Example 59

### Boat Fiberglass

Upon a fiberglass boat deck Polyurea 350 from CFFS mixed 50% by volume Bright White Prism grout from CPB. The resulting mixture is rolled onto the substrate with a ⅜″ roller.

### Example 60

### Steel Coating

Upon a steel bridge structure CFFS 511 primer is applied with a paint sprayer and allowed to dry for 4 hours. Upon the primer RG-80 from CFFS with 35% by volume earth Prism grout from CPB using a brush.

### Example 61

### Combustion Engine Muffler

Upon a muffler which has a defect in it a base coat of Polyurea 350™ product mixed with equal parts by volume charcoal rism grout from CPB is brushed on and a fiberglass mesh is embedded in the coating and covering the defect. This entire repair is then covered with a brush applied coat of the same product.

### Example 62

### Hockey Stick

Upon a fiberglass hockey stick a coat of Polyurea 350 mixed with equal parts by volume charcoal Polyblend Sanded grout from CPB is brushed on.

### Example 63

### Boots and Ice Skates

Upon a pair of work boots, shoes or ice skates a base coat of Polyurea 350 mixed with equal parts by volume charcoal Polyblend Sanded grout from CPB is brushed on and a fiberglass mesh is embedded in the coating. This entire repair is then covered with a brush applied coat of the same product.

### Example 64

### Enclosed Trailer

Upon a wood floor for and enclosed trailer Polyurea 350 mixed with equal parts by volume Oyster Gray Polyblend Sanded grout from CPB is rolled on to the surface with a ⅜″ roller. Within a 30 minute window the floor is covered by a broadcast of Torginol® chips “Denim” until rejection. The floor is allowed to cure for 2 hours and then a clear top coat of PG-100 from CFFS is applied with a flat squeegee and back rolled with a ⅜″ roller. The floor is than ready for foot traffic in 6 hours and full service in 24 hours.

### Example 65

### Undercoating

The underside and floor boards made of steel in an automobile or truck is prepared by sanding with 80 grit sandpaper and cleaned with Acetone. Upon this surface a mixture of RockSolid DIY Bed liner combined with 75% by volume charcoal Prism from CPB is applied with a Schultz Gun.

### Example 66

### One Day Floor

A concrete floor is etched with RockSolid Safe Etch from CFFS per manufactures instructions. After the floor has dried for 2-3 hours Polyurea 350 mixed with equal parts by volume white VersaBond fortified thin-set mortar from CPB is rolled on to the surface with a ⅜″ roller. Within a 30 minute window the floor is covered by a broadcast of Torginol® chips “saddle tan” until rejection. The floor is allowed to cure for 2 hours and then a clear top coat of RG-80 from CFFS is applied with a flat squeegee and back rolled with a ⅜″ roller. The floor is than ready for foot traffic in 6 hours and full service in 24 hours.

### Example 67

### One Day Floor

A concrete floor is etched with RockSolid Safe Etch from CFFS per manufactures instructions. After the floor has dried for 2-3 hours Polyurea 350 custom base is mixed with equal parts by volume Fawn Polyblend Non-sanded grout from CPB. To this mixture 10% by volume Acetone is added. The floor is than ready for foot traffic in 6 hours and full service in 24 hours.

### Example 68

### u.v. Curable Coating

Upon a concrete floor, a mixture of CFFS Insta-Coat™ UV Cure Aliphatic Urethane is mixed with 20% by volume of fawn Polyblend Non-sanded grout from CBP using a flat blade squeegee. After 30 minutes the floor is then cured using a Bulldog® 15-1700A UV light machine from HID Ultraviolet of Sparta, N.J.

### Example 69

### Increase Slip Resistance on Existing Tile Floor

A ceramic tile floor is sanded with an 80 grit sandpaper and subsequently wiped clean with acetone. Upon the fresh surface, a layer prepared from mixing CFFS PG-100™ and an equal part by volume of CBP “fawn” grout is applied using a Spraymate™ hopper.

### Example 70

Polyurea 350™ Traffic Coat Gray product from CFFS is combined with 10% of its volume of gray Rebus tint and blended until a uniform mixture results using conventional mechanical mixing.

### Example 71

Polyurea 350™ product from CFFS is mixed with an equal part by volume of non-sanded grout in fawn color from CBP, and fawn Prism grout from CPB in an amount equal to 10% by volume based on the volume of the Polyurea 350™ product used. The materials are blended using mechanical mixing.

The materials of examples 70, 71 were tested using a modified ASTM WK 14355 test. The floor coatings were applied onto a Masonite® board surface in a single coat and allowed to cure for either 24 hours or 48 hours at 65 F before testing. A 4″×4″ sample was cut out of the applied board and placed coating side against a passenger tire tread. A 4″×4″ piece of ¾″ board was then placed both on top of the back side of the tire tread, and the back side of the coated Masonite® board. A “C” clamp was then used to force intimate contact of the tire tread against the coating surface by tightening the clamp by hand with a 12″ long lever until it could not be tightened further. The assembly was then placed into an oven held at 140° F. (60 C) for 24 hours. The assembly was removed at the end of 24 hours and allowed to condition back to room temperature for 30 minutes before taking apart. The coating was then viewed for black tire marks, other surface effects, and loss of adhesion. Results of the tests are in Table VII below:

TABLE VII

| | Time tested | |
|---|---|---|
| Example | 24 hrs. | 48 hrs. |
| 70 | Loss of gloss | Loss of gloss |
| | Dark black marks present that | Light black marks present that |
| | could not be wiped away | could not be wiped away |
| 71 | No loss of gloss | No loss of gloss |
| | Presence of very light marks | Presence of slight darkened |
| | that were easily wiped away | marks that were easily wiped |
| | | away |

In the testing of examples 70, 71, neither example showed a loss of adhesion. These tests results clearly show that the material containing grout according to this disclosure has much better chemical resistance and early coating integrity versus the standard coating in the absence of added grout.

In addition to opening the door to many new color possibilities, compositions according to embodiments of the disclosure exhibit improved chemical resistance over coatings in the prior art which is believed to enable a floor surface such as a concrete garage floor surface to be coated and returned to automobile traffic within 24 hours, in some embodiments with a one-coat system. Three compositions that return the floor to service within 24 hours are exemplarily illustrated in the examples. However, mortars and/or grouts may also be combined with any of the compositions described in my co-pending application Ser. No. 12/001,372 filed Dec. 11, 2007 which is incorporated by reference herein, using any level of grout or mortar described this disclosure in any composition taught in my co-pending application.

Although this invention has been described and disclosed in relation to various embodiments, modifications, combinations, and alterations of the features of various embodiments disclosed may become apparent to persons of ordinary skill in this art after reading and understanding the teachings of this specification, drawings, and the claims appended hereto. The present disclosure includes subject matter defined by any combinations of any one (or more) of the features, elements, or aspects present described in reference to any embodiment described in this disclosure with one or more feature(s), element(s), or aspect(s) described in relation to any other one (or more) embodiments described. These combinations include the incorporation of the features and/or aspect(s) of any dependent claim, singly or in combination with features and/or limitations of any one or more of the other dependent claims, with features and/or limitations of any one or more of the independent claims, with the remaining dependent claims in their original text being read and applied to any independent claims so modified. These combinations also include combination of the features and/or limitations of one or more of the independent claims with features and/or limitations of another one or more of the independent claims to arrive at a modified independent claim, with the remaining dependent claims in their original text or as modified per the foregoing, being read and applied to any independent claim so modified.

1. A composition useful as a coating for a substrate, comprising a coating material in combination with at least one other material selected from the group consisting of: mortars and grouts, said at least one other material being evenly distributed within the bulk of said composition.

2. A composition according to claim 1 wherein said at least one other material comprises both a grout and a mortar.

3. A composition according to claim 1 wherein said coating material is a curable reactive mixture from which a polymeric coating selected from the group consisting of: polyurethanes, epoxies, polyureas, moisture-cure urethanes, acrylics, single-component polyureas, polyaspartic esters, and ultraviolet light curable materials, including any mixtures thereof in any proportions, is formed from curing of said coating material.

4. A composition according to claim 1 wherein said coating material is selected from the group consisting of: water-based coating materials, oil-based coating materials, and solvent-based coating materials.

5. A composition according to claim 1 wherein said coating material is a paint selected from the group consisting of: oil-based paints and water-based paints.

6. A composition according to claim 1 wherein the amount of said at least one other material present is any amount between about 5% and about 200% by volume based on the total volume of said coating material present in said composition, including all volume percents and ranges of volume percents therebetween.

7. A composition according to claim 1 wherein said at least one other material is present in the form of a powder comprising particles, wherein the average size of the particles is any size between about one micron and about one millimeter, including all average sizes and all ranges of average sizes therebetween.

8. A composition according to claim 1 wherein said at least one other material is present in the form of a powder comprising particles, wherein the average size of the particles is any size between about fifteen microns and about 350 microns, including all average sizes and ranges of average sizes therebetween.

9. A composition according to claim 1 wherein when a grout is selected, said grout includes a polymeric material present in an effective amount to reduce shrinkage of said grout during its cure when said grout is combined with water and cured.

10. A composition according to claim 9 wherein said polymeric material is selected from the group consisting of latex polymers and acrylate polymers.

11. A composition according to claim 1, disposed on said substrate, wherein said substrate is selected from the group consisting of: a floor surface, a wall surface, a roof surface, a surface on a steel structure, a deck surface, and a ceiling surface, said composition being disposed on said substrate.

12. A composition according to claim 11 disposed on a substrate, wherein said composition is sufficiently cured within about 24 hours of application of said composition to said substrate, to support automobile traffic without substantial damage occurring to said sufficiently-cured composition.

13. A composition according to claim 1 further comprising a material selected from the group consisting of glass bubbles and ceramic microspheres in any amount between about 0.1% by weight and about 10% by weight based on the total weight of said composition, including all weight percents and ranges of weight percents therebetween.

14. A composition according to claim 1 present in the form of a layer on a concrete substrate, said composition including an effective amount of said at least one other material to increase the adhesion between said concrete and said composition when cured, as compared to said coating material by itself.

15. A composition according to claim 1 wherein said composition is uncured and workable.

16. A composition according to claim 1 wherein said composition is cured.

17. A composition according to claim 16 wherein said composition further comprises a fiberglass mesh material of any mesh size and fiber size embedded within its bulk.

18. Method for coating a substrate with a layer of material comprising:
providing a composition according to claim 1;
applying said composition to a substrate; and
allowing said composition to cure.

19. Method according to claim 18 wherein said applying is carried out using an implement selected from the group consisting of: rollers, brushes, squeegees, spatulas, and spray-generating equipment.

20. Method according to claim 18, further comprising repeating said method in order to provide a second layer of said material atop said layer.

21. Method according to claim 18 wherein said substrate is selected from the group consisting of: a floor surface, a wall surface, a roof surface, a surface on a steel structure, a deck surface, and a ceiling surface.

22. Method for repairing a defect in a metallic structure comprising:
providing a composition according to claim 1;
applying a first amount of said composition to said defect;
applying a fiberglass mesh over said first amount of said composition;
applying a second amount of said composition to said defect, over said fiberglass mesh; and
permitting said composition to cure.

23. Method according to claim 22 wherein said metallic structure comprises a combustion engine exhaust component selected from the group consisting of, muffler pipes, mufflers, catalytic converters, and exhaust manifolds.

24. Method according to claim 22 wherein said defect is a hole.
